(19) United States
(12) Patent Application Publication
(10) Pub. No.: US 2006/0190332 A1
(43) Pub. Date: Aug. 24, 2006

(54) Method and device for dispensing and purchasing customized gift cards

(76) Inventor: Jeffrey S. Grider, Annandale, NJ (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/352,890

(22) Filed: Feb. 13, 2006

Related U.S. Application Data
(60) Provisional application No. 60/652,158, filed on Feb. 11, 2005.
(60) Provisional application No. 60/676,349, filed on Apr. 29, 2005.
(60) Provisional application No. 60/676,529, filed on Apr. 29, 2005.

(51) Int. Cl. G06Q 30/00; G06F 17/00

(52) U.S. Cl. 705/14; 700/231; 700/235

(57) ABSTRACT

A system, method and processor-readable storage medium for purchasing a gift card are disclosed. Information may be received identifying an amount and a merchant for a gift card. The purchaser of the gift card may provide payment information. The information identifying the amount and the merchant for the gift card may be stored after receiving the information. The gift card may be printed such that the amount and the merchant are visible on the surface of the gift card. The gift card may then be dispensed to the purchaser.

### CROSS REFERENCE TO RELATED APPLICATIONS

This application is based on and claims priority from U.S. Provisional Patent Application Ser. Nos. 60/652,158, 60/676,349, and 60/676,529, all of which are hereby incorporated by reference.

### BACKGROUND

A loyalty card, rewards card, points card, discount card or club card is a plastic card, similar in size and shape to a traditional credit card or debit card, that identifies the cardholder-consumer as a participant in a merchant's incentive program (hereinafter, any such card or other means for identifying a cardholder-consumer shall be referred to as a “loyalty card”). Such loyalty cards typically have a barcode, magnetic stripe, computer chip or radio identification (“RFID”) tag that can be easily scanned at the point of sale (hereinafter, “POS”) such as a check-out counter in order to uniquely identify the cardholder-consumer (or cardholder-consumer's household or other extended group).

As shown in FIG. 1, a typical presentation of a loyalty card 12 to the consumer might be embedded in a punch-out loyalty combination card 10 which is a larger plastic card template that also includes smaller punch-out key tags 14 that can be used by the consumer at the POS to eliminate the need to carry the larger loyalty card 12 itself. Such key tags would include the same barcode 16 as the loyalty card or include an encoded magnetic stripe, computer chip or RFID tag containing the same information as the magnetic stripe, computer chip or RFID tag of the loyalty card 12 to identify the consumer as the loyalty cardholder at the POS.

Presentation of a loyalty card or associated key tag typically entitles the consumer to a discount on his current purchase or to an allotment of points that might be used for future purchases or other benefits with a merchant. The loyalty card therefore creates an incentive for the consumer to continue to frequent the merchant and can create for the merchant an opportunity to collect and analyze a cardholder-consumer's purchase history in order to conduct marketing research to offer more individualized and targeted purchasing and discount opportunities for the consumer based on his purchase history.

Traditionally, to obtain a loyalty card, a consumer had to complete a paper application that had to be manually entered into the merchant's computer system, which might utilize third party data processing and cleansing services, for example and without limitation, to verify address information. The merchant's computer system stored the consumer's identification information obtained through the application. Although the consumer might receive and use the loyalty card to receive discounts or points immediately upon completion of the paper application while at the merchant, the actual association of the consumer identification information with the loyalty card identification information (e.g., barcode number or other loyalty identification number or other information present on the magnetic stripe or computer chip) did not occur until the consumer identification information and the loyalty card identification information were entered into and processed by the merchant's computer system. Due to the labor-intensive paper process and errors in the manual processing of applications, consumer identification information would often be inaccurate or even disassociated completely from the loyalty identification information (e.g., if the merchant's clerk failed to attach a label including the barcode number of the loyalty card to the consumer's paper application when processing the loyalty card application). While online or Web-based loyalty card application procedures have been introduced to decrease the data entry errors and increase the success rate of associating consumer identification information the loyalty identification information, the loyalty cards cannot be immediately presented to the consumer, as compared to the in-store paper application process.

Similar shortcomings are also known in the gift card industry. As used in this specification, the term “gift card” refers to any prepaid card, including gift cards, travel cards, payroll cards, flexible spending account prepaid cards, transit system fare cards, telephone prepaid calling cards or any other cards that can be used for purchasing goods or services of the gift card recipient=3 s choice. Traditionally, in contrast to loyalty cards, gift card recipients may remain anonymous and their personally identifiable information is not electronically associated with the gift card; however, anonymity is not essential to the present invention.

Similar to the loyalty card, the gift card is typically a plastic card similar in size and shape to a traditional credit card or debit card. The gift card typically has a barcode, magnetic stripe, computer chip or RFID tag that can be easily scanned at the POS. Gift cards are issued and redeemed at a single merchant or a group of merchants, or are issued or otherwise associated with a bank or other money transmitter. Gift cards can optionally operate in conjunction with a payment card association or other payment network and may be used at any merchant that accepts other payment instruments associated with the association or payment network. The dollar value associated with gift cards can be stored at the related merchant's database or a third party gift card settlement and processing center and is accessed through gift card identification information printed or otherwise encoded on the gift card, such as a barcode number or an encoded magnetic stripe.

Alternatively, a gift card may be a stored value card wherein a representation of the dollar amount of the card is actually stored on the card rather than referenced through gift card identification information associated with the card. Gift cards have traditionally been pre-printed and pre-valued at fixed amounts. Merchants would activate such pre-printed and pre-valued cards at the POS prior to selling them to the consumer. More recently, merchants are able to dynamically assign gift card values at the POS according to a consumer's request. Nevertheless, such gift cards remain pre-printed. Therefore, the consumer's requested dollar value is not reflected on the actual gift card itself and accompanying written documentation must be provided to inform the recipient of the gift card's value. The pre-printed and fixed dollar amount nature of gift cards make a self service gift card device impractical due to the difficulties of stocking different pre-printed cards for the different merchants and stocking different fixed dollar amounts for each merchant's pre-printed cards.

Additionally, traditional methods for distributing loyalty cards and/or selling gift cards may require that the consumer-cardholder have to interact directly with personnel of or on behalf of the merchant. Such personnel are typically necessary to ensure that the consumer-cardholder provides the requested information (such as via a pre-printed enrollment form), that the consumer is provided with the correct card, that the card is properly associated with the consumer, and similar responsibilities. As a result, traditional methods are prone to potential human error and significant personnel costs.

### SUMMARY

In an embodiment, a device may dispense loyalty cards and/or customized gift cards. With respect to loyalty functionality, such a device may include an internal scanner that scans the loyalty identification number (e.g., barcode number) of a loyalty combination card prior to dispensing such card to the consumer in order to associate such loyalty identification information with consumer identification information that is obtained from the consumer by the device during an enrollment process. With respect to gift card functionality, such a device may include an internal printer that prints in real-time any graphical customizations requested by the consumer and may include an internal magnetic stripe encoder that encodes the gift card value amount and/or gift card identification information and merchant identification information on the gift card prior to dispensing such card to the consumer.

In an embodiment, a system for providing a gift card may include an input interface for receiving information identifying an amount for a gift card, a payment interface for receiving payment for the gift card, a storing device for storing the information identifying the amount for the gift card after receiving the information, a printer for printing the gift card such that the amount is visible on the surface of the gift card, and a dispenser for dispensing the gift card.

In an embodiment, a method of purchasing a gift card may include receiving information identifying an amount for a gift card, receiving payment information from the purchaser of the gift card, storing the information identifying the amount for the gift card after receiving the information, printing the gift card such that the amount is visible on the surface of the gift card, and dispensing the gift card to the purchaser.

In an embodiment, a processor-readable storage medium may contain one or more programming instructions for performing a method of purchasing a gift card. The method may include receiving information identifying an amount for a gift card, receiving payment information from the purchaser of the gift card, storing the information identifying the amount for the gift card after receiving the information, printing the gift card such that the amount is visible on the surface of the gift card, and dispensing the gift card to the purchaser.

### BRIEF DESCRIPTION OF THE DRAWINGS

FIG. 1 depicts a conventional combination punch out loyalty card template.

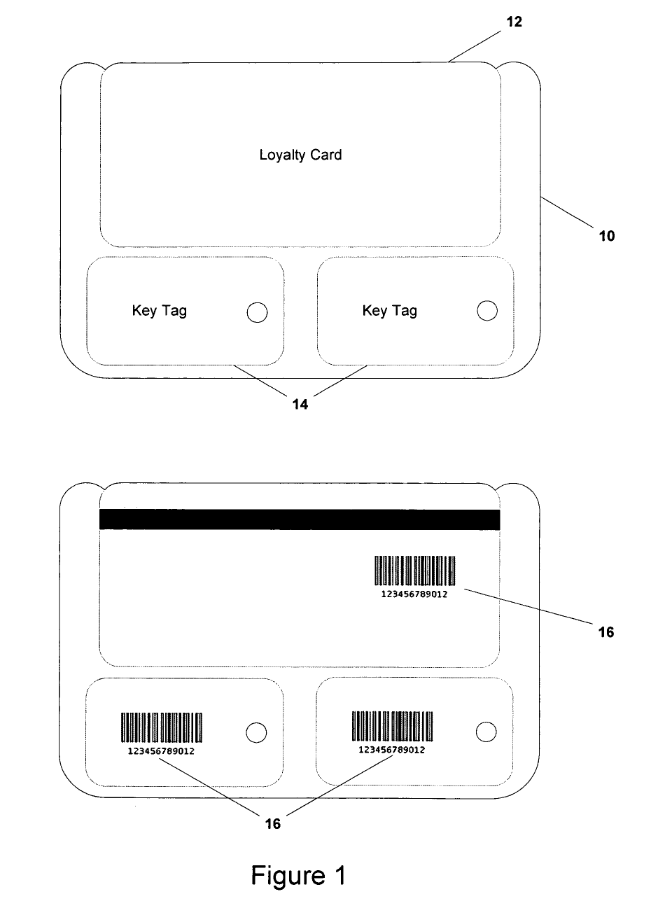

FIG. 2 depicts an exemplary device in accordance with an embodiment.

FIG. 3 depicts an exemplary networked device architecture in accordance with an embodiment.

FIG. 4 depicts a flow chart describing an exemplary interaction of a consumer with a device in accordance with an embodiment for enrollment with a merchant loyalty program.

FIG. 5 depicts a flow chart describing an exemplary interaction of a consumer with a device in accordance with an embodiment for purchasing gift cards.

### DETAILED DESCRIPTION

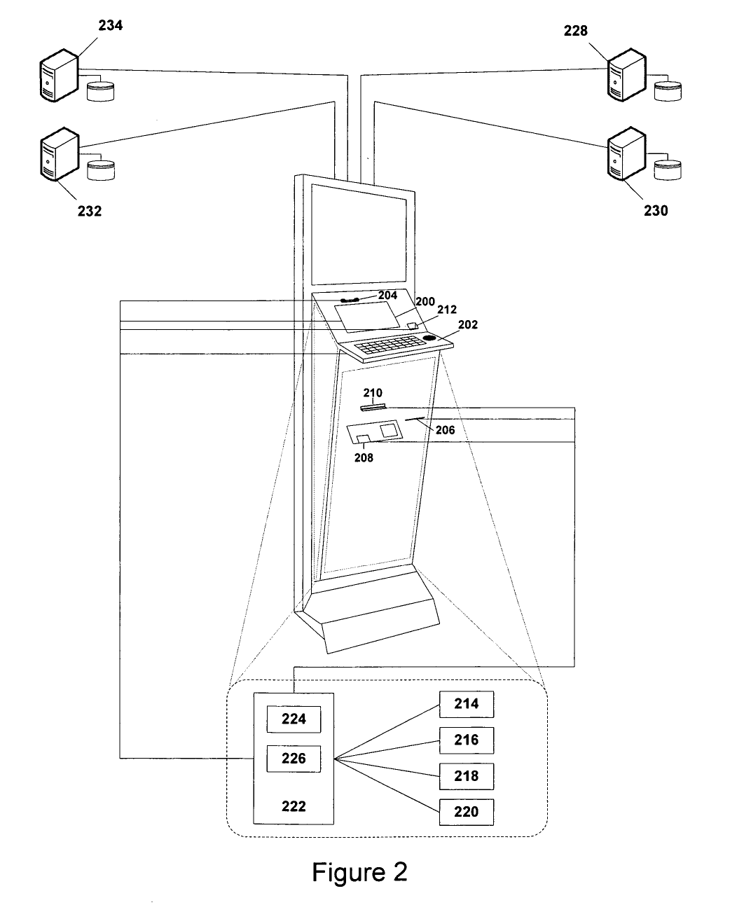

FIG. 2 depicts a device in accordance with an embodiment. In an embodiment, a device with loyalty functionality may be presented in a location in which an attendant is not resident, such as, for example and without limitation, in a strategically visible area near the entrance of a merchant, in an automated in-lane check-out counter or otherwise in conjunction with any other enrollment process, including enrollment to participate in biometric-based payment transactions. Similarly, a device with gift card functionality may be presented, for example and without limitation, in a shopping mall, a shopping promenade, a retail store or other shopping or retail area.

In an embodiment, a device may include a screen 200 that may have touch screen functionality, a user input device 202 such as a keyboard and/or track ball, a card reader 204 such as a magnetic stripe reader that may have the functionality to read loyalty cards, gift cards, or credit and/or debit cards (or any combination thereof), a printer 206 that may have the functionality to print receipts and/or coupons, a dispenser 208 that may have the capability to dispense loyalty cards, loyalty combination cards and/or gift cards, a scanner 210 that may have the capability to scan driver's licenses or other identification cards, and a biometric scanner 212 such as a fingerprint scanner for identification, verification and/or payment purposes.

Those of ordinary skill in the art will recognize that alternative components known in the art may be used to provide similar functionality as described in the foregoing without departing from the scope of this disclosure. For example and without limitation, a barcode scanner may be utilized rather than a magnetic stripe reader as the card reader 204 to read loyalty cards. Similarly, the scanner 210 might be an image scanner, magnetic stripe scanner, barcode scanner or any other scanner known to those of ordinary skill in the art. Similarly, additional or other biometric devices, such as an eye scanner, voice analyzer or handprint scanner, may be used as an addition and/or alternative to a fingerprint scanner. Similarly, a bill acceptor may be used in accordance with an embodiment in order to enable a consumer to purchase gift cards using cash.

Internally, a device in accordance with an embodiment may include an internal barcode scanner 214 to scan the barcode number of the loyalty combination card, loyalty card or gift card prior to or as the dispenser 208 dispenses such card to the consumer, an internal printer 216 for printing customized cards, storage areas 218 to store cards (for both blank and/or pre-printed cards) for dispensing, and a magnetic stripe encoder 220 to encode value on customized gift cards. The various components of a device may be in communication with an internal computer system 222 that includes, for example, control logic 224 and a local data store 226 for managing the interaction among the consumer, the various device components and external computer systems in communication with the device. Such external computer systems may include, for example, merchant computer networks 228, centralized servers that perform remote database management and processing services 230, computer systems of gift card settlement and processing companies 232, and computer systems for credit card and debit card processing companies 234.

The control logic of the internal computer system 222 may include business rules to ensure that complete information is entered by the consumer prior to dispensing a card; automated address lookup and field population when certain consumer identification information (e.g., phone number) is entered into the system by the consumer via the user input device 202; logic to verify and/or extract consumer identification information from a scanned driver's license or other identification cards; centralized monitoring logic for network communication with a merchant's computer system or third party database management and processing servers, including to report device hardware and software failures, transaction histories, consumable levels, supply of cards in the device, and the need to replace printer cartridges and/or ribbons; logic to biometrically identify and/or authenticate a consumer; logic to activate a customized gift card; and logic to associate loyalty identification information (e.g., barcode number, etc.) with consumer identification information.

The local data store of the internal computer system 222 may include a searchable coupon database that may be accessible to the consumer via the screen 200 and printer 206; a gift card design database including different graphical backgrounds and designs that can be printed on blank cards by the internal printer 216; a database of available loyalty identification information and/or gift card identification information such as available barcodes and barcode numbers that, for example and without limitation, may be printed on blank cards by the internal printer 216 and/or encoded by the magnetic stripe encoder 220; and a database to store and associate consumer identification information with loyalty identification information.

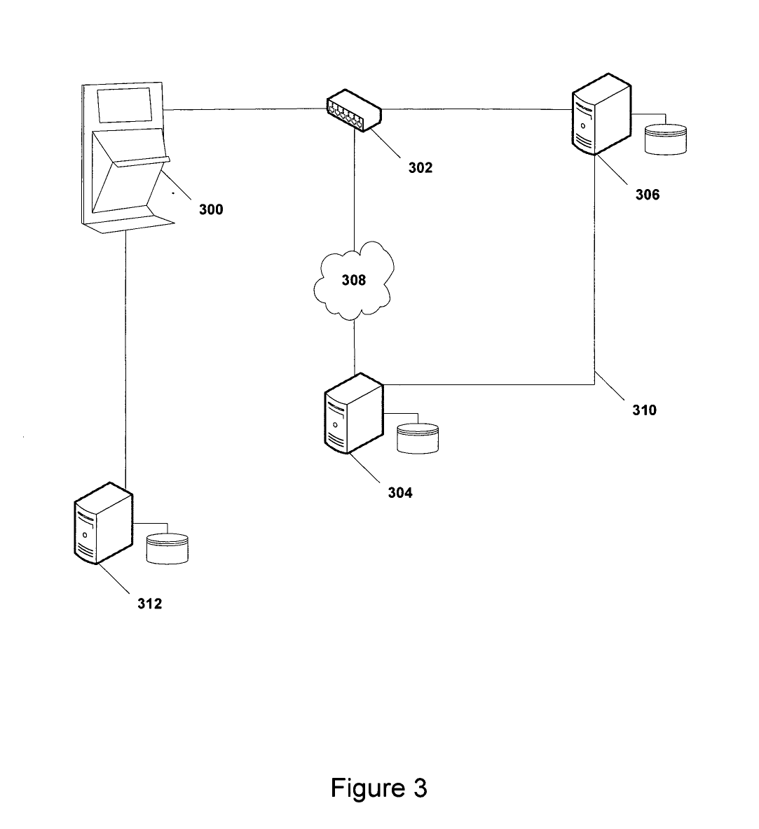

In an embodiment, a device may be in communication with external computer systems such as a database management and processing server, a gift card settlement and processing center and/or a merchant's proprietary computer network system. Those of ordinary skill in the art will recognize that such communication can be implemented in a variety of known techniques and manners. For example and without limitation, as depicted in FIG. 3, a device 300 may be in communication with an external database management and processing server 304 through the merchant's in-store computer network 302. The external database management and processing server 304 may be in further communication with the related merchant's back-end centralized computer system and database 306. If the merchant's in-store computer network 302 supports wireless networking technology, the device 300 may communicate with the database management and processing server 304 wirelessly. As those of ordinary skill in the art will recognize, the communication among the device 300, the database management and processing server 304, and the merchant's back end centralized computer system and database 306 may be implemented through a variety of private or proprietary networked connections or through the Internet or other publicly accessible networks.

In an embodiment depicted in FIG. 3, the device 300 may be granted wireless Internet access through the merchant's in-store network 302 such that communication between the device 300 and the database management and processing server 304 is conducted through secured channels over the Internet 308. In an embodiment, the database management and processing server 304 may be in communication with the merchant's own back-end centralized computer system and database 306 through a private network channel 310. In an embodiment, the external database management and processing server 304 may store consumer identification information, including associated merchant-specific loyalty identification information and consumer payment preferences and capabilities (e.g., check cashing, credit card, debit card, electronic stored value accounts, etc.) in a biometrically secured electronic wallet. Similarly, with respect to gift card functionality, the device 300 may communicate with the merchant's own back end centralized computer system 306 as well as a third party gift card settlement and processing service 312.

Those of ordinary skill in the art will recognize that the control logic and data stored and used by the various computer systems as depicted, for example, in FIG. 3 is merely illustrative and may be distributed throughout the various computer systems' logic controls and databases in alternative but functionally equivalent designs without departing from the scope or spirit of the described embodiments. For example and without limitation, in a biometrically enhanced embodiment, a biometric sample received by the biometric scanner of the device 300 (e.g., for the purpose of purchasing gift cards) may be transmitted to the database management and processing server 304 wherein logic resides to compare the received biometric sample to an stored authenticated biometric template of the consumer in order to confirm the consumer's identity. In an alternative embodiment, upon the request of the device 300 such an authenticated biometric template may be transmitted to the device 300, and the comparison of the biometric sample against the authenticated biometric template may be performed locally at the device 300 using, for example, control logic resident in the computer system 220 of the device.

Similarly, a database of gift card custom backgrounds and designs for different merchants may be stored either locally at the device 300 and/or centrally at the database management and processing server 304 in order to facilitate the updating and distribution of such designs to multiple devices in a merchant's system. Such backgrounds and designs may also be stored at one or more other computer systems in communication with the device 300.

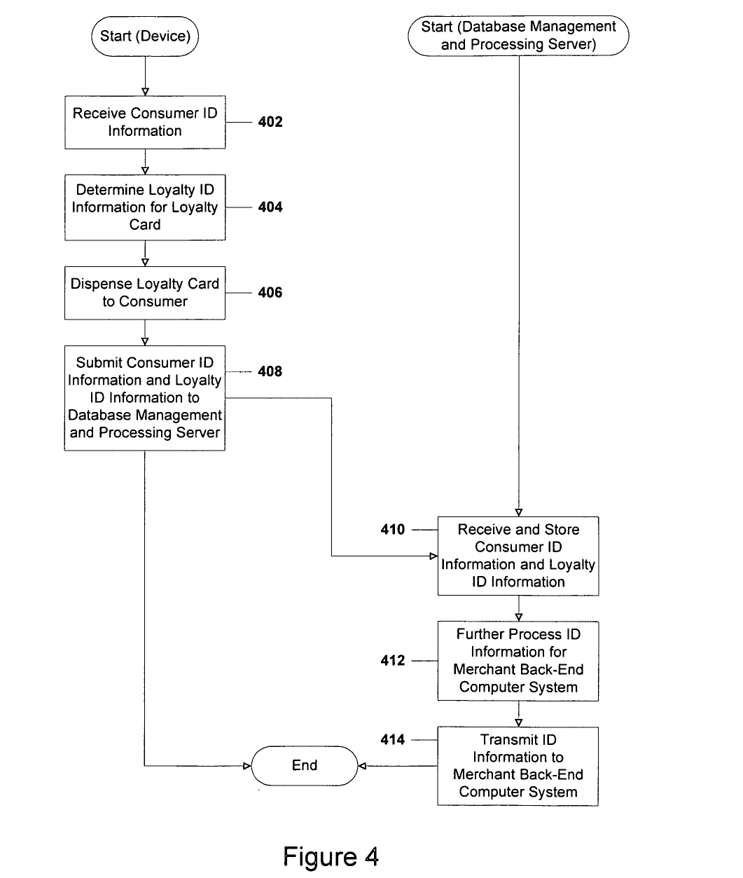

FIG. 4 depicts a flow chart describing the interaction of a consumer with a device in accordance with an embodiment for enrollment with a merchant loyalty program. The device may request and receive (Step 402) consumer identification information from the consumer. Such information may include, for example, the consumer's name, address, phone number, household statistics, retail preferences, birth date, and any other information that may be valuable in conducting consumer behavior analysis, and may additionally include consumer payment preference information (e.g., credit cards, debit cards, charge cards, etc.). Such consumer identification information (or at least a subset thereof) may be entered by the consumer through a keyboard 202 or touch screen 200 or by scanning a driver's license, credit or debit card or any other card possessed by the consumer that includes identification information. An embodiment may also include a data transfer interface that enables the consumer to provide consumer identification information to the merchant through, for example, a Web page. Such an interface may permit a consumer to retrieve identification information if, for example, the consumer did not have sufficient identification information on-hand to complete the enrollment process while on premises at the merchant. Similarly, to the extent that such an online data transfer interface also includes a biometric scanner (e.g., embedded on the consumer's laptop or coupled to the consumer's home computer system), the consumer may begin and complete the submission of consumer identification information through the online data transfer interface, including the submission of a biometric sample, wherein the consumer may visit a device in accordance with the present invention that is on the premises of the consumer and by submitting his biometric sample via the biometric scanner 212, obtain his loyalty card or loyalty combination card. Such an online-enhanced embodiment may further enable the consumer to print out barcode scans and/or numbers related to the consumer's loyalty identification information from a consumer's home computer system. In a biometrically enhanced embodiment, the device may receive at least one biometric sample, such as a fingerprint scan, from the consumer to create an authenticated biometric template. The biometric template may then be included as part of the consumer identification information. The device may interact in real-time with external third party computerized services to verify the accuracy and completeness of some or all of the consumer identification information (e.g., name, address, phone number, etc.) to the extent desired by the merchant. Such confirmation services may also be outsourced to the database management and processing server.

The device may internally scan (Step 404) the barcode number of a next available loyalty combination card stored in the device using its internal barcode scanner 214, which may be installed near the mouth of the dispenser. The device may associate this loyalty identification information with the consumer's own identification information. In an alternative embodiment, a barcode and barcode number or other loyalty identification information may be dynamically assigned to the consumer and printed in real-time on a blank and customizable loyalty card or loyalty customization card prior to the dispensing of such card.

The device may dispense (Step 406) the loyalty card or loyalty combination card, including, for example, one or more key tags, to the consumer. The consumer may immediately use the loyalty card or key tags at a POS of the merchant during his checkout process. In a biometrically enhanced embodiment, the consumer may also obtain loyalty discounts or points by submitting a biometric sample at a POS, which includes a biometric scanner. The biometric sample may be compared with the authenticated biometric template submitted at enrollment to validate the transaction. In such an embodiment, the biometric scanner at the POS may communicate with the database management and processing server via a network connection in order to obtain the authenticated biometric template submitted at enrollment.

The device may submit (Step 408) the consumer identification information, including the associated loyalty identification information, to an external database management and processing server. Submitting the consumer identification information and associated loyalty identification information may occur immediately upon completion of the enrollment process (i.e., upon the consumer's receipt of the loyalty card or loyalty combination card) or in batch mode at the end of the day or during intervals of the day, after the aggregation of a number of consumer enrollments.

The database management and processing server may store (Step 410) the consumer identification information and associated loyalty identification information in an electronic wallet for the consumer and may verify the accuracy of consumer identification information. The database management and processing server may further process (Step 412) the consumer identification information and the associated loyalty identification information into a format that is acceptable by the merchant's own back-end computer system and database.

The database management and processing server may transmit (Step 414) at least a subset of the consumer identification information and associated loyalty identification information to the merchant's own back-end computer system and database enabling the merchant to associate purchases and discounts made at the POS of the merchant under particular loyalty identification information with the identify of the actual consumer. Similar to Step 408, the transmission of this information to the merchant's own back-end computer system and database may be performed immediately in real-time or in batch mode.

The foregoing enrollment process may enable a consumer to shop at the merchant and, upon submission of a loyalty card, key tag or biometric sample for scanning at the POS of the merchant, obtain loyalty discounts or points that can ultimately be associated with the consumer's identity by the merchant. Such an architecture, in accordance with an embodiment, may enable merchants to analyze a consumer's purchasing habits and offer more targeted discounts and other purchasing opportunities on an individualized basis. Such analysis may lead to opportunities for the merchant, such as offering targeted coupons, incentives or discounts to the consumer upon the consumer's subsequent interaction with the device. The consumer may initiate such interaction by sliding or scanning his loyalty card or key tag through the device's external card reader 204 or by submitting biometric information through a biometric scanner 212. Non-biometric embodiments might also request that the consumer enter further consumer identification through the touch screen 200 or the user input device 202, for example and without limitation, such as the first three letters of the consumer's last name, in order to provide a level of authentication that the consumer is the true owner of the card.

The consumer may also subsequently visit the device in order to update consumer identification information. Upon the consumer's sliding or scanning of his loyalty card or key card submission or his finger scan through the biometric scanner 212, the device may request and receive from the database management and processing server 304 the consumer's current consumer identification information, which it may then display to the consumer for updating on its screen 200. For example and without limitation, a consumer may wish to associate biometric samples of other members of his household (or otherwise associate such members' own electronic wallets) with the consumer's loyalty identification information such that all members of the household may benefit from loyalty discounts or points at a biometrically enabled POS. More simply, a consumer may also wish to update a consumer mailing address at which targeted marketing or coupons mailed by received.

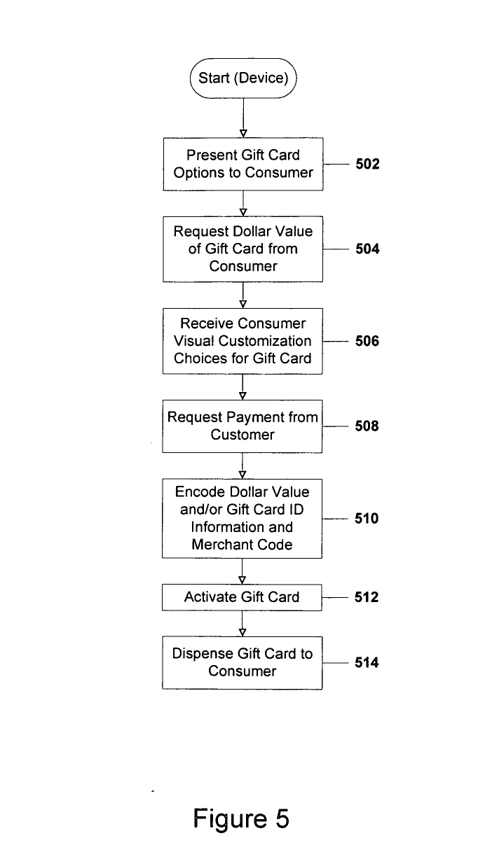

FIG. 5 depicts a flow chart describing the interaction of a consumer with a device in accordance with an embodiment for the purchasing of gift cards. The device may display (Step 502) on a screen 200 to the consumer a variety of gift card choices and options, for example and without limitation, a single merchant gift card (for a variety of different merchants), a multi-merchant gift card (i.e., a single card that may be used at several different merchants) or a pre-paid bank card (i.e., a pre-paid card similar to a debit card that is accepted anywhere the bank's debit card is accepted). If the consumer selects a single merchant gift card, the consumer may then select a single merchant from a list of participating merchants presented by the device. Similarly, if the consumer selects a multi-merchant gift card, the consumer may then select multiple merchants from a list of participating merchants presented by the device or, alternatively, may select from prearranged groupings of merchants presented by the device.

Upon the consumer's selection of the gift card type, the device may request the consumer to select a value for the gift card in Step 504. Depending upon merchant or merchants selected for the gift card, a variety of fixed amounts (e.g., $20, $50, $100) may be presented to the consumer, or, alternatively, any amount may be accepted. In an embodiment, the device may present fixed or variable amounts in a plurality of currencies.

The device may receive the consumer's choices for customizing the visual presentation of the gift card (or, alternatively, the consumer may select the merchant's or a merchant group's standard visual presentation) (Step 506). For example and without limitation, the device may offer the consumer a variety of backgrounds relating to holidays, special events, special interests and/or specific third party designs related to a type of gift card and/or a particular merchant or merchant group. Similarly, the device may offer the consumer the capability to customize “To” and/or “From” fields on the gift card and additionally or otherwise add a special message on the gift card. Once the consumer has completed any desired customizations by using, for example, the device's touch screen and/or keyboard, the device may request and receive payment from the consumer in Step 508. Payment may be submitted by the consumer as cash through a bill acceptor in the device; in the form of a debit, credit or charge card through a magnetic stripe reader 204 in the device; or in the form of a biometric sample through a biometric scanner 212 in the device, which if verified, may unlock the consumer's electronic wallet and any preferred payment mechanisms therein. In an embodiment of a biometrically enhanced version, the device may request from the consumer an additional personal search number or secret personal identification number in order to facilitate the search for the consumer's authenticated biometric template within a biometric template database (which may be in a secure remote location separate from the device) and against which the biometric sample must be verified. Once the payment request and all funds are processed (including through networked communication with the appropriate payment processing entities), the device may move the next available blank gift card from the internal card storage area 218 of the device to an internal printer 216 that prints the consumer-requested customizations onto the gift card.

The device may utilize (Step 510) its internal magnetic stripe encoder 220 to encode the dollar value and one or more relevant merchant codes onto the gift card. In an embodiment, the device may utilize the internal printer 216 to additionally print a card number, barcode and barcode number, secret PIN and/or other gift card identification information on the card, for example and without limitation, to create and associate an anonymous account at the merchant and/or gift card settlement and processing service with the gift card identification information on the card. As such, the gift card recipient may be able to use the card for online transactions or other transactions where a physical reading of, for example, a magnetic stripe cannot be performed.

In alternative embodiments, the magnetic reader may encode only gift card identification information and merchant identification information onto the gift card, while the actual dollar value and balance of the card may be stored and managed in anonymous accounts in the computer systems of, for example, the merchant or the gift card settlement and processing service. Such anonymous accounts may be simultaneously created by the merchant computer systems and/or the gift card settlement and processing services during networked communication with the device during a consumer's customization and purchase of the gift card.

The device may activate (Step 512) the gift card upon ensuring that the purchase funds are transferred to the account of the selected merchant or merchants or to the gift card processing and settlement service. This activation step may also ensure that an anonymous account at the merchant or gift card processing and settlement service that is associated with any gift card identification information is credited in an amount equal to the purchase price of the gift card.

The customized and activated gift card may then be dispensed (Step 514) to the consumer. In addition to the sale of customized gift cards, a consumer may also use a device in subsequent visits to, for example, check the balance of, or add additional value to, a previously purchased gift card through its card reader 204.

Although the present invention has been described with reference to the alternative embodiments, those of ordinary skill in the art will recognize that changes may be made in form and detail without departing from the spirit and scope of this disclosure. Terminology used in the foregoing description is for the purpose of describing the particular versions or embodiments only, and is not intended to limit the scope of the present invention which will be limited only by the appended claims. Thus, for example, reference to a “biometric template” is a reference to one or more biometric templates and equivalents thereof known to those of ordinary skill in the art including biometric images captures, for example and without limitation, full and/or stitched fingerprint images, and so forth. Similarly, reference to a “device” is a reference to one or more devices and equivalents known to those of ordinary skill in the art. For example and without limitation, a device may refer to a standalone enclosed cabinet or, alternatively, an area where the various components of the device are separate (e.g., printers, encoders, computer system, etc.) and unenclosed but are nevertheless logically and physically coupled in accordance with the descriptions herein, or even a virtual online device that is implemented through the Web. Similarly, reference to use of barcodes and/or encoded magnetic stripes in the foregoing descriptions are not meant to restrict or limit the scope of the present invention, and those of ordinary skill in the art will recognize that other alternative technologies including smart card chips or RFID tags may be readily used in alternative embodiments of the present invention. As used herein and in the appended claims, the singular forms “a,” “an,” and “the” include plural references unless the context clearly dictates otherwise. Similarly, the words “include,” “includes” and “including” when used herein shall be deemed in each case to be followed by the words “without limitation.” Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are herein described. All publications mentioned herein are incorporated by reference. Nothing herein is to be construed as an admission that the invention is not entitled to antedate such disclosure by virtue of prior invention. Thus, various modifications, additions and substitutions and the like can be made without departing from the spirit of this disclosure and these are therefore considered to be within the scope of the invention as defined in the following claims.

What is claimed is:

1. A device for providing a gift card, comprising:
an input interface, wherein the input interface receives information identifying an amount for a gift card;
a payment interface, wherein the payment interface receives payment for the gift card;
a storing component, wherein the storing component facilitates the storing of the information identifying the amount for the gift card;
a printer, wherein the printer prints the gift card such that the amount is visible on the surface of the gift card; and
a dispenser, wherein the dispenser dispenses the gift card.

2. The device of claim 1 wherein the input device further receives information identifying a merchant for a gift card and the printer further prints the gift card such that the merchant is visible on the surface of the gift card.

3. The device of claim 1 wherein the storing component comprises an encoder, wherein the encoder encodes a storage medium integral to the gift card with the amount for the gift card, wherein the storage medium comprises one or more of a magnetic stripe, a processor-readable storage medium, and a radio frequency identification (RFID) tag.

4. The device of claim 1 wherein the storing component comprises a communication interface for transmitting gift card identification information and the amount for the gift card for storage.

5. The device of claim 4 wherein the gift card comprises a storage medium comprising one or more of a magnetic stripe, a processor-readable storage medium and an RFID tag, wherein the storage medium contains the gift card identification information.

6. The device of claim 1, further comprising:
a scanner, wherein the scanner scans gift card identification information from the gift card.

7. The device of claim 1, further comprising:
a processor, wherein the processor determines gift card identification information for the gift card.

8. The device of claim 7 wherein the printer further prints the gift card information on the gift card.

9. A method of purchasing a gift card, the method comprising:
receiving information identifying an amount for a gift card;
receiving payment information from the purchaser of the gift card;
storing the information identifying the amount for the gift card;
printing the gift card such that the amount is visible on the surface of the gift card; and
dispensing the gift card to the purchaser.

10. The method of claim 9, further comprising:
receiving information identifying a merchant for a gift card; and
printing the gift card such that the merchant is visible on the surface of the gift card.

11. The method of claim 9 wherein the storing step comprises encoding the amount of the gift card on one or more of a magnetic stripe, a processor-readable storage medium and an RFID tag that are integrated into the gift card.

12. The method of claim 9 wherein the storing step comprises transmitting gift card identification information and the amount for the gift card for storage.

13. The method of claim 12 wherein the storing step further comprises encoding the gift card identification information onto one or more of a magnetic stripe, a processor-readable storage medium and an RFID tag that are integrated into the gift card.

14. The method of claim 9, further comprising:
scanning gift card identification information from the gift card.

15. The method of claim 9, further comprising:
determining gift card identification information for the gift card.

16. The method of claim 15, further comprising:
printing the gift card identification information on the gift card.

17. The method of claim 9, further comprising:
receiving a background design selection for the gift card.

18. The method of claim 9, further comprising:
receiving a message for the gift card.

19. The method of claim 18 wherein the message comprises information pertaining to a recipient of the gift card.

20. The method of claim 9 wherein receiving payment from the purchaser comprises one or more of the following:
receiving cash from the purchaser;
performing a credit card transaction;
performing a debit card transaction; and
scanning biometric information from the purchaser.

21. The method of claim 9 wherein printing the gift card further comprises printing one or more of a purchaser selected background and a message on the gift card.

22. A processor-readable storage medium containing one or more programming instructions for performing a method of purchasing a gift card, the method comprising:
receiving information identifying an amount for a gift card;
receiving payment information from the purchaser of the gift card;
storing the information identifying the amount for the gift card;
printing the gift card such that the amount is visible on the surface of the gift card; and
dispensing the gift card to the purchaser.

23. The processor-readable storage medium of claim 22, further containing one or more programming instructions for performing the following:
receiving information identifying a merchant for a gift card; and
printing the gift card such that the merchant is visible on the surface of the gift card.

24. The processor-readable storage medium of claim 22 wherein storing the information identifying the amount comprises encoding the amount of the gift card on one or more of a magnetic stripe, a processor-readable storage medium and an RFID tag that are integrated into the gift card.

25. The processor-readable storage medium of claim 22 wherein storing the information identifying the amount comprises transmitting gift card identification information and the amount for the gift card for storage.

26. The processor-readable storage medium of claim 25 wherein storing the information identifying the amount further comprises encoding the gift card identification information onto one or more of a magnetic stripe, a processor-readable storage medium and an RFID tag that are integrated into the gift card.

27. The processor-readable storage medium of claim 22, further containing one or more programming instructions for:
scanning gift card identification information from the gift card.

28. The processor-readable storage medium of claim 22, further containing one or more programming instructions for performing the following:
determining gift card identification information.

29. The processor-readable storage medium of claim 28, further containing one or more programming instructions for performing the following:
printing the gift card identification information on the gift card.
